(19) United States
(12) Patent Application Publication
(10) Pub. No.: US 2005/0129921 A1
(43) Pub. Date: Jun. 16, 2005

(54) Molded article with foam-encased reinforcing member

(76) Inventors: R. Dru Laws, Orem, UT (US); David J. Laws, Provo, UT (US); Phillip Swindler, Provo, UT (US); Nick Olson, Orem, UT (US); Kip M. Colton, Eagle Mountain, UT (US); Nikki Colton, Eagle Mountain, UT (US)

Correspondence Address: THORPE NORTH & WESTERN, LLP., 8180 SOUTH 700 EAST, SUITE 200, P.O. BOX 1219, SANDY, UT, 84070, US

(21) Appl. No.: 11/009,186

(22) Filed: Dec. 10, 2004

Related U.S. Application Data
(60) Provisional application No. 60/529,006, filed on Dec. 12, 2003.

(51) Int. Cl. B32B 3/26; B29C 41/04; B29C 41/20; B28B 1/02; A23G 1/00; B28B 1/00; A23G 3/00; B28B 21/00; A01J 25/12; A01J 21/00; A21C 3/00; A23P 1/00; B32B 5/20; G01B 1/00; B29C 31/00

(52) U.S. Cl. 428/304.4; 264/310; 264/279; 425/435; 428/318.8

(57) ABSTRACT

A molded article includes a rotationally-molded body of polymer material, formed in a mold, with an elongate reinforcing member, having an end, substantially encased within the body of polymer material during molding thereof. A slip zone, defining a void in the body of polymer material, is formed around the end of the reinforcing member, such that post-molding shrinkage of the polymer material imposes substantially no stress on the end of the reinforcing member.

### PRIORITY CLAIM

The present application claims priority from U.S. Provisional Patent Application Ser. No. 60/529,006, filed on Dec. 12, 2003.

### BACKGROUND OF THE INVENTION

1. Field of the Invention

The present invention relates generally to molded polymer articles. More particularly, the present invention relates to a molded polymer article with an expanded foam core and a reinforcing member encased within the foam core.

2. Related Art

Polymer materials have come into use for the fabrication of lightweight articles, such as tables, risers, kayaks, etc. Some of these types of articles include plastic layers or grid frameworks as reinforcing members, with outer plastic layers in various forms. They may be fabricated by forming a skin, such as by blow molding, rotational molding, or vacuum forming to produce a plastic shell, with a frame disposed in the shell or connected to the exterior of the shell to add structural rigidity. In some cases, an expansive foam material, such as polyurethane foam, may be injected into the shell to fill the interior and increase the stiffness of the molded article.

Other methods have been developed for rotational molding of such articles, including methods that produce a rotationally molded polymer article having a polymer shell with a foam core produced in a single step or “one-pass” molding process. Additionally, these methods allow the production of a molded article having an integrated structural frame that is encased by the foam core. Such processes can produce high quality lightweight reinforced plastic articles or structures, and include fewer steps and fewer secondary processes than some prior methods.

Unfortunately, an integrated structural frame presents certain additional challenges with one-pass molded articles. The structural frame generally has different thermal expansion and shrinkage characteristics than the polymer material, both the polymer shell and the foam core. After the molding process is complete, the polymer table will tend to shrink significantly, both because of cooling and because of phase-change densification of the polymer materials. However, an integral frame member, which is frequently of metal, such as steel, will have no phase-change related shrinkage, and will experience significantly less thermal shrinkage because its coefficient of thermal expansion is much smaller than that of the polymer material. If the polymer material bonds or adheres to the frame, the differential shrinkage of these members can produce significant internal stress inside the molded article. The result of these factors is that the molded article is much more likely to experience undesirable post-molding deformation because of the internal stress and differential shrinkage of the components of the article. This deformation can include warping of the article as a whole, localized deformities, local cracking of polymer material, and crushing of the form core material against the ends of the frame members.

### SUMMARY OF THE INVENTION

It has been recognized that it would be advantageous to develop a molded article with a foam core and an encased reinforcing member that resists post-molding shrinkage-related deformation.

It would also be advantageous to develop a molded article wherein there is minimal internal stress created by differential post-molding shrinkage of the foam core and frame.

It would also be desirable to develop a system and method for producing such a molded article.

In accordance with one aspect thereof, the invention provides a molded article, having a body of polymer material, formed in a mold, an elongate reinforcing member, having an end, substantially encased within the body of polymer material during molding thereof, and a slip zone around the end of the reinforcing member. The body of polymer material and the reinforcing member have unique post-molding shrinkage properties. The reinforcing member has a surface that substantially eliminates adhesion with the polymer material, so as to enable displacement of the reinforcing member with respect to contacting polymer material. The slip zone defines a void in the body of polymer material, such that post-molding shrinkage of the polymer material imposes substantially no stress on the end of the reinforcing member.

In accordance with another aspect thereof, the invention provides a system for forming a molded polymer article around a reinforcing member. The system includes a mold, having an inside, a mount attached to the inside of the mold, and a reinforcing member held in place within the mold by the mount. The mount includes a stiffener cavity into which the reinforcing member is placed, the reinforcing member being held in place during molding of the article.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a pictorial view of a molded tabletop having a foam core with a reinforcing member encased therein, in accordance with the present invention.

FIG. 2 is a cross-sectional view of the molded tabletop of FIG. 1.

FIG. 3 is an elevation view of a rotational molding system configured for forming a molded article in accordance with the present invention.

FIG. 4 is a pictorial view of an open mold having mounts, attached to the inside of the mold, configured for receiving and holding reinforcing members in place during rotational molding of an article therearound.

FIG. 5 is a close-up perspective view of one of the mounts shown in FIG. 4.

FIG. 6a is a perspective view of a blind fastener configured to be encased within the molded article.

FIG. 6b is a side edge view of the blind fastener of FIG. 7a encased within a molded table top.

FIG. 7 is a plan view of a molded article having an encased reinforcing member with a shrink zone formed around an end of the reinforcing member.

FIG. 8 is a cross-sectional view of a mold configured for making a molded article in accordance with the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention advantageously provides a molded article or structural member and a system and method for manufacturing the same. The system and method can be used to produce a wide variety of different molded articles in accordance with the invention. One example of such a molded article is a molded table 10 shown in FIGS. 1, 2, and 7. The table shown in these figures comprises a rotationally-molded body 12 of polymer material, with an internal frame 14, for providing structural reinforcement, substantially encased within the polymer material. In the embodiment shown, the molded body comprises an outer polymer shell or skin 18, and an expanded polymer foam core 20 disposed within the shell and encasing the reinforcing members. The polymer shell or skin and foam core 18 can be of a variety of thermoset plastic or thermoplastic materials, such as polyethylene, polypropylene, polyvinyl chloride, or composite polyester. Other materials may also be used. The polymer materials may contain additives such as ultraviolet light inhibitors, anti-oxidants, reagents, or color additives, as desired. Additionally, the shell and core may be of similar or dissimilar polymer materials.

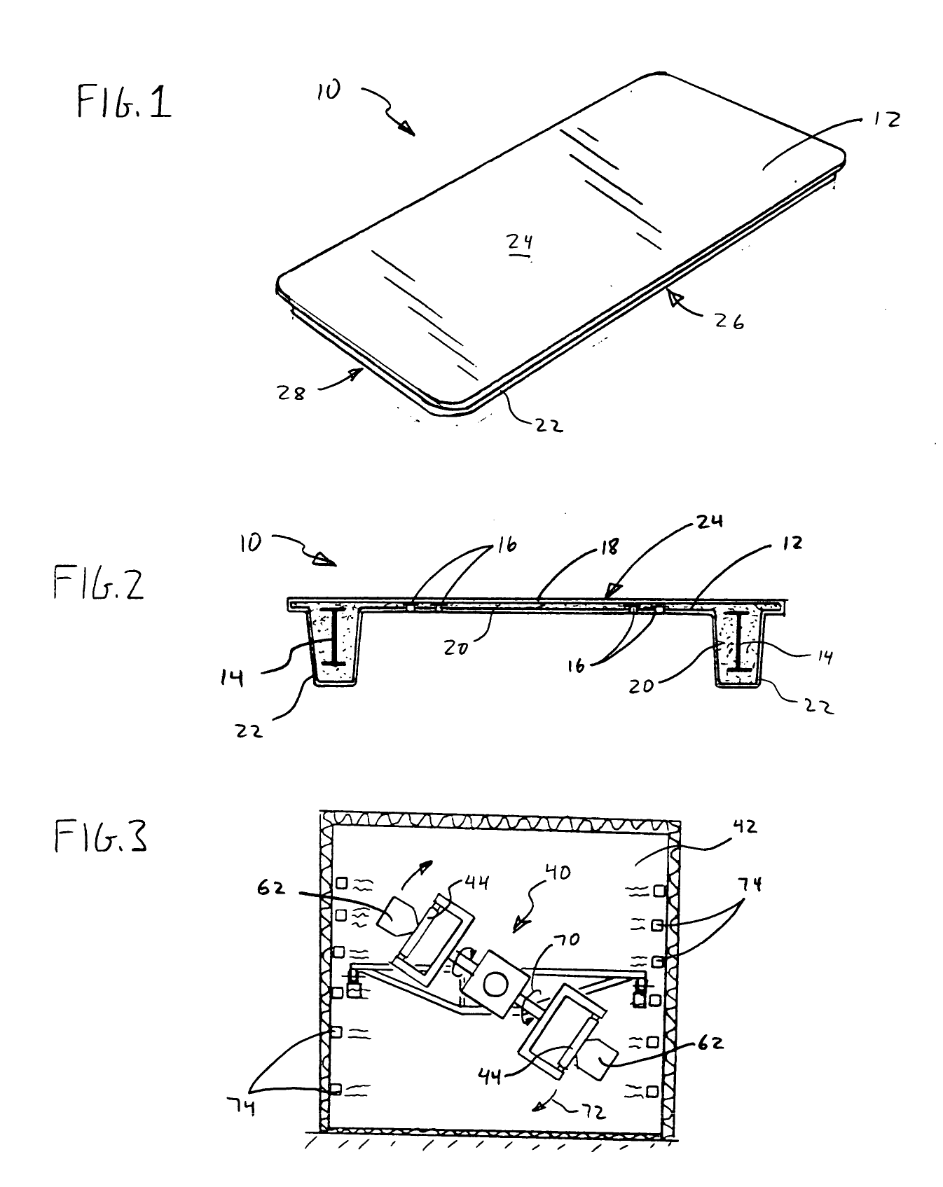

The table frame 14 shown in FIG. 2 comprises elongate beams or table runners, in this case a structural “I” beam shape. It will be apparent that other shapes of reinforcing members can be used, such as solid rectangular shapes, tubular members, channels, etc., and these may be of a variety of materials, such as wood, metals, polymers, composites, etc. Polymers and composites can be used for reinforcing members so long as they are stable at and are not damaged by temperatures that will be reached during the molding process.

It will be apparent that the location and configuration of reinforcing members will depend on the shape and intended use of the molded article. For the table shown, the frame is incorporated into a skirt 22 which extends downwardly from the tabletop portion 24. It will be apparent that the table frame can be placed in other locations and have a different configuration from that shown. For example, the table frame may include beams or runners 14 along the long sides 26 and also on the short sides 28 of the table, and may also include one or more transverse or diagonal frame members (not shown) extending between the longitudinal beams. It is also conceivable that the table could be configured without an internal frame at all, or with only longitudinal frame members, such as only in the skirt 22 on the long sides 26 of the table. Alternatively, the table may have a frame that extends only around its perimeter, whether in the skirt or table top 24. Many other framed and unframed configurations are also possible.

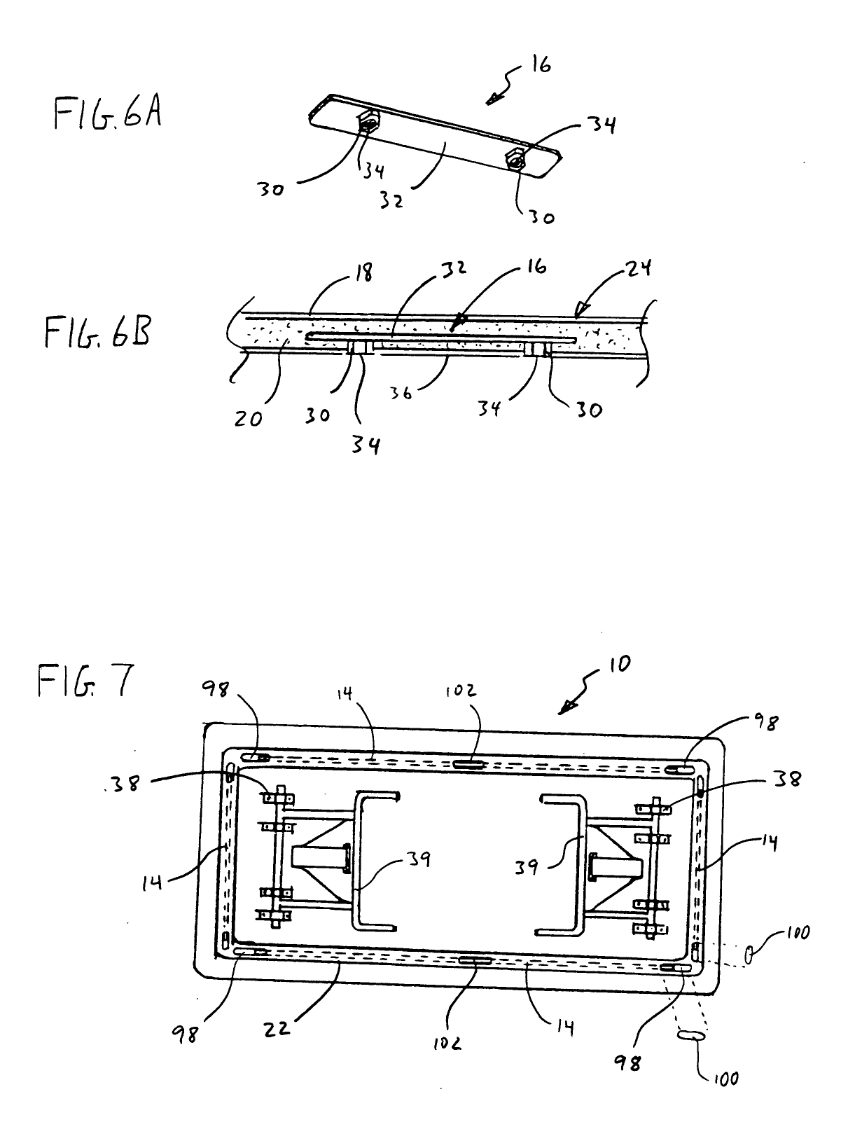

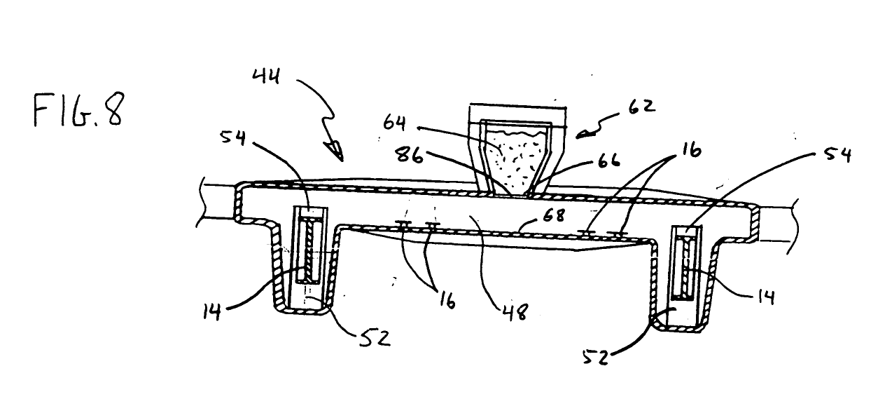

The molded article can also include attachment points 16 that are encased within the polymer body, to provide attachment points for external structure, such as brackets 38 for a folding table leg assembly 39, as shown in FIG. 7. One type of useful attachment point is a blind fastener, shown in FIGS. 6A and 6B. The blind fastener comprises internally threaded nuts 30 attached (e.g. welded) to a metal backing plate 32. The nut has a threaded opening 34, and the blind fastener is disposed such that the threaded opening of the nut is substantially flush with an exterior surface 36 of the molded article, so that the threaded opening will be exposed on the surface of the finished article, and the backing plate will be substantially completely encased within the polymer material of the foam core 20. The backing plate serves several functions. The large size of the backing plate provides a large surface area for anchorage in the foam core. The backing plate also holds the nuts at the appropriate spacing. Additionally, the backing plate shields the back side of the threaded openings of the nuts from entry of polymer material during molding.

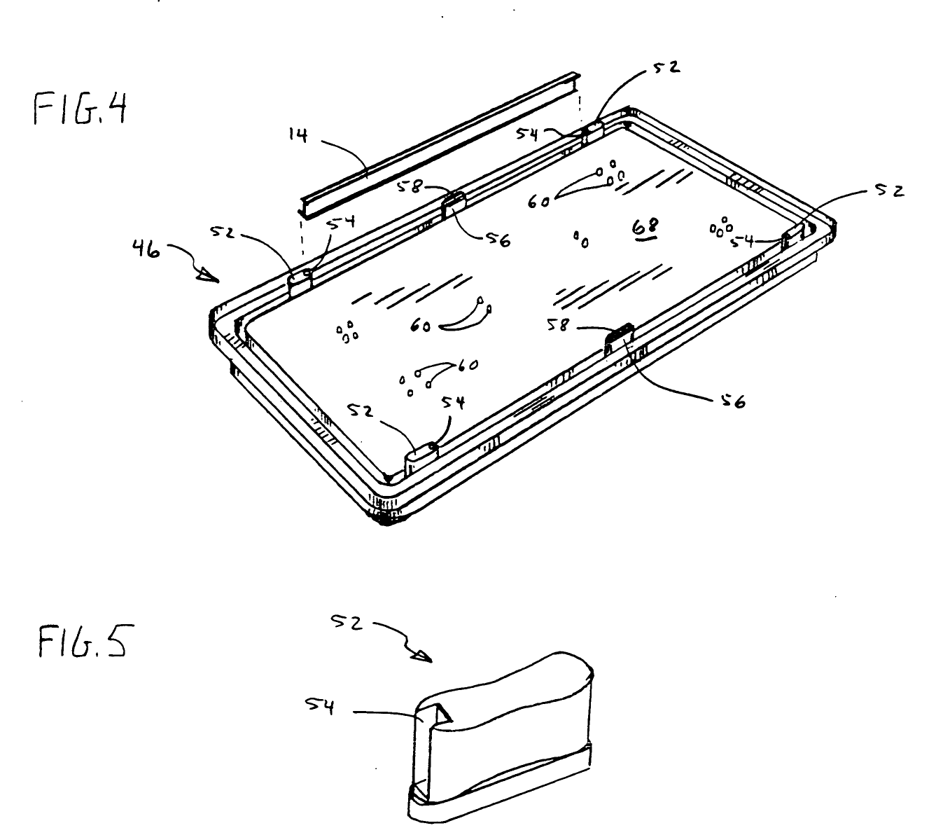

Advantageously, a molded article with all of these elements can be completely formed in a mold in a single step. The method produces a very strong article which is durable, resists delamination of the skin from the foam core, and interacts as a unit with the reinforcing members. The apparatus for making a molded table in accordance with the invention is depicted in FIGS. 3, 4, 5 and 8. FIG. 3 depicts a rotational molding apparatus 40 disposed within a large oven 42 configured for heating the mold while it rotates about multiple axes. FIGS. 4 and 8 provide different views of a mold 44 suitable for producing a table having a cross-section like that of FIG. 2. The lower half 46 of the open mold is shown in FIG. 4, while FIG. 8 provides a cross-sectional view of the closed mold assembly. The mold can be manufactured from metals, such as cast aluminum, fabricated sheet aluminum, or other suitable cast or composite materials, such as steel, iron, etc. Cast aluminum appears to provide a good balance between cost, weight, and heat transfer characteristics.

In order for the reinforcing members and attachment points to become substantially encased in the polymer material of the molded article, they must be held in a proper position within the interior of the mold (48 in FIG. 8). There are several ways that this can be accomplished. For example, the mold can include pins (not shown) for supporting and holding the frame within the inner cavity of the mold. Such pins can be attached to the inside walls of the mold, and operate to support or suspend the structural frame within the inner cavity of the mold prior to and during the molding process as it becomes encapsulated by the skin and expanded foam material. The pins may be of metal, and may be adjustable or removable from outside the mold. Alternatively, the pins may be of a polymer material which melts and becomes part of the tabletop during the heating and molding process.

Alternative frame supports are shown in FIGS. 4, 5 and 8. The frame supports comprise a mount 52, attached to the inside of the mold 44. The mount can be of metal, such as aluminum, or of a suitable polymer material. The mount includes a stiffener cavity 54, configured for receiving an end of the reinforcing member 14. During molding of the article, the reinforcing member is held in the stiffener cavity by mechanical fasteners (e.g. threaded bolts) or by magnets, or some other suitable attachment method. In the view of FIG. 4, the reinforcing member is an elongate beam having opposing ends. The mount shown in FIG. 5 is an end mount configured for receiving one of the ends of the reinforcing member into the stiffener cavity. The elongate shape of the mount operates to block out a region of polymer material around the end of the reinforcing member for reasons that are discussed below.

Where the reinforcing member 14 is relatively short, such as on a short end 28 of the table, two end mounts 52 disposed at opposing ends of the elongate member can be sufficient. Where the reinforcing member is relatively long, such as along the long sides 26 of the table, an intermediate mount 56 can be provided to stabilize a center region of the reinforcing member within the mold. The intermediate mount includes a through-slot 58 that allows passage of the reinforcing member, but helps maintain its location and upright orientation during the molding process. The frame 14 may also be supported within the mold 44 in other ways. For example, the frame can be supported within the mold cavity by attachment plates, bolt sockets, or other mechanical fastener-related structures (not shown) which extend to or through the mold walls.

As shown in FIG. 4, the bottom portion 46 of the mold 44 also includes pins 60 for holding the attachment points or blind fasteners 16 in place. Because the blind fasteners are disposed flush with the outer surface 36 of the finished article, the pins for holding them in place may comprise threaded fasteners that mate with the threaded openings 34 of the blind fasteners. Alternatively, the blind fastener pins can comprise magnetic pins for holding the fasteners in place. The mold can also include other features that are common for such molds, such as breather tubes (not shown), which help equalize pressures in the mold and allow gasses to escape.

The process of molding an article in accordance with the invention can proceed in one of several different ways, and the configuration of the mold will depend on the particular method employed. One method involves the use of a drop box or canister 62 disposed on the outer periphery of the mold 44, as shown in FIG. 8. Drop boxes are well known in the art of rotational molding. The drop box is designed to hold materials 64 which are intended to “drop” or flow into the mold at a set time (or temperature) during the rotational molding process. Such materials can include one or more raw polymer materials, foaming agents, or other materials. The drop box is mounted on the outer periphery of the exterior mold surface, with an access hole 66 provided from its interior chamber to the inner cavity 48 of the mold.

The drop box includes a door 86 or other device that can be opened pneumatically, electrically, hydraulically, or by some other method to allow its contents to flow into the mold. Opening of the drop box may be controlled electrically, through either a hard-wired connection, or a wireless radio frequency control system, or through other electrical, mechanical, or chemical processes. For example, the drop box can include a mechanical plunger (not shown) that normally blocks the opening to the mold, but when actuated by an actuator draws away from the access hole to allow the materials stored inside the canister to flow into the inner cavity of the mold. Multiple drop boxes or a drop box with multiple chambers (not shown) can also be attached to a single mold to allow more than one “drop” or discharge of material into the mold during the molding process.

In each version of the process, whether using a drop box or not, the mold 44 is first opened and its interior surface 68 is treated with a release agent, which allows the finished product to be easily removed from the mold. Suitable release agents include silicones, Teflon, etc. These and other suitable release agents are well known in the art, and are readily commercially available. Following treatment of the interior surface of the mold, the desired reinforcing members, such as a structural load-bearing frame 14, attachment points 16, etc. are then inserted into the inner mold cavity 48. This step may also include the installation of pins, mounts, mechanical fastener-related structures, or other devices described above for holding the frame and attachment points in the proper location during molding.

After insertion of the frame and/or other reinforcing members, raw polymer material, usually in the form of powder or pellets (though liquids may also be used, and these may be sprayed onto the interior surface 68 of the mold), is placed into the mold 44 in accordance with any of several different methods. In one method, the raw polymer material placed into the mold at the outset of the process is only that material needed for forming the thin polymer shell or skin 18 of the table. The polymer material for forming the polymer shell can be configured (such as by including additives) to provide various desired properties, including color, abrasion resistance, opacity, translucence, multiple color surfaces, impact resistance, and structural strength.

At this point, with the frame and the polymer for forming the shell in place, the mold 44 can be closed. Then, one or more drop boxes 62 are attached to the mold, and one or more raw polymer materials are placed into the drop box(es). These materials are usually also in the form of powder or pellets. The mold is then attached to the rotational molding machine 40 and placed within the oven 42, as shown in FIG. 3. The rotational molding machine is configured to slowly, continuously rotate the mold about two orthogonal axes, as shown by arrows 70, 72, within the oven so as to allow the polymer material to spread evenly throughout the mold while being simultaneously heated. Suitable rotational speeds vary from about 1 rpm to about 16 rpm. Rotational speeds in the range of about 6 rpm to about 8 rpm are frequently used.

As the mold rotates, the polymer for forming the skin 18 is caused to spread out within the mold. Simultaneously, the oven 42, having heating elements 74, heats the mold, which causes the polymer particles to begin to melt and adhere to the inner surface 68 of the mold. It will be apparent that a variety of heating systems can be used for heating the oven, such as gas-fired convection systems, etc. The result of the heating and rotating is to form an exterior shell of the melted skin polymer around the entire inner surface of the mold.

At a preset time or temperature, the drop box 62 opens, allowing its contents 64 to flow into the mold. The material from the drop box can be a second polymer material containing reagents that will cause the second polymer material to “blow” or foam in a controlled manner at a predetermined decomposition temperature to form the foam core. This temperature may be approximately the same as the temperature at which the skin forms. However, because the drop box is thermally insulated, the second polymer will not have reached that decomposition temperature by the time the first or shell polymer does. Consequently, the same material, e.g. polyethylene, may be used for both the shell and the foam core, the only difference being that the polymer of the core includes the blowing agent so as to expand into a foam, while the shell polymer does not. Because of the timing of their exposure to the reaction temperature, the desired reactions will occur at different times.

Many “drops” of polymer materials, colors, or reagents may be made into the mold cavity as desired, whether from a single drop box having more than one chamber (not shown), or from multiple drop boxes (not shown). For example, after the first polymer material is allowed to form the shell 18, a second shell polymer material (without a foaming agent) may be dropped into the mold, to form a second shell layer inside the first. Thus one or more additional layers of polymer may be deposited inside the outer shell layer. The second and subsequent layers of polymers preferably have characteristics (such as different melting temperatures) such that each layer will mold, in sequential order, after the primary shell has been formed.

The heating cycle heats the mold and its contents from room temperature up to a certain maximum temperature, depending on the specific properties of the polymer materials that are being used. In one embodiment of the invention, using polyethelyne for the shell material, the temperature at which the shell begins to form is about 270° F., and the temperature at which the foam core forms is about 310° F. However, with other materials, the temperatures will differ. The melt temperature of nylon, for example, whether for the shell or the foam core, is between about 347° F. and 509° F.

A variety of different materials can be placed into the mold 44 at the beginning of the process (without using a drop box) and still produce the different layers. Where these materials have different properties, they can form successive layers of the table, including both the shell 18 and foam core 20, even while intermixed. For example, each shell layer material may have a slightly different melt temperature, such that it will melt and adhere to the inside 68 of the mold (or the preceding material) at different times during the molding process. Alternatively, polymer pellets of various sizes may be simultaneously introduced into the mold, each size melting and reacting at different times during the heating cycle. In general, the smaller the pellet, the faster the melt—similar to a time-release system.

Many different kinds of foam materials may be used for the foam core in connection with the above-described methods. For example, two kinds of olefinic foams have been used by the inventors. Azodicarbonamide foams produce nitrogen gas (N₂) and carbon dioxide (CO₂), as the blowing agents, but also produce ammonia (NH₄) and carbon monoxide (CO) as byproducts. Obviously, carbon monoxide is poisonous, and ammonia has an objectionable smell, and is also toxic in large quantities. Alternatively, sodium bicarbonate-based foams have also been used, these producing carbon dioxide (CO₂) as the blowing agent, with no objectionable byproducts.

One advantage of this method is that olefinic foams are substantially less expensive than injected foams, such as polyurethane foam. Thus, the method of this invention allows less expensive foam materials to be used for lightweight table cores which could not be used before. Olefinic foams with the blowing agents previously discussed also produce far less fluid pressure (˜5 psi) than injected urethane foams (which produce ˜40-50 psi), thus allowing their use in relatively lightweight and less expensive rotational molds. The “blowing” or foaming reaction of sodium bicarbonate-based foams is an endothermic reaction. However, exothermic foaming agents can also be used in accordance with the method of this invention.

The maximum temperature may be maintained for some period of time to allow the desired reactions to go to completion, or upon reaching the desired temperature, the heating cycle may be immediately discontinued. In one embodiment of the invention, the heating cycle lasts approximately 25 minutes. When the heating cycle is completed, the mold assembly is removed from the oven, and placed in a cooling area (not shown) for a given time period. In one embodiment of the invention, the cooling cycle lasts for about 35 minutes. While the mold is cooling, additional material drops may also be made in the inner cavity of the mold. After cooling, the mold may be opened and the molded part removed, after which the process can be repeated.

The method as described produces a combination of a foam core, encapsulated within a polymer shell having one or more layers, to produce a plastic table that is very strong and has high impact resistance. Advantageously, the foam core and polymer skin may be of the same species of material, simply in different forms or densities (i.e. foam vs. higher density skin), thus providing an integral transition from the core to the skin, and thereby drastically reducing the possibility of delamination.

The table structure can also be modified with a variety of cosmetic and functional features. For example, inserts of various kinds (not shown) can be placed in the mold before molding, so as to be incorporated into the finished table. These may include laminate inserts for the tabletop, protective edge bands, facia pieces, and the like. For example, a layer of ultra-thin Corian® or other durable laminate material could be placed into the mold to provide a tabletop that has superior surface qualities in an inexpensive polymer shell. This process could be used to produce things such as laboratory benches, and highly impermeable surfaces for use where granite and other such materials are currently used. It will be apparent that laminates and other such additions could also be applied to the finished tabletop after the molding process is complete.

One challenge presented by rotationally-molded articles is shrinkage and deformation after molding. The elongate reinforcing member 14 in the completed table 10 is in direct contact with the foam material of the core 20. The polymer material of the table body, both the foam core and the shell or skin 18, has post-molding deformation characteristics, primarily post-molding shrinkage due to both thermal cooling and phase-change densification. The reinforcing member, which is frequently of metal, such as steel, experiences no phase-change densification related shrinkage, and will experience significantly less shrinkage related to cooling because its coefficient of thermal expansion is much smaller than that of the polymer material. This shrinkage induces internal stress in the article, and, depending upon the geometry of the article, this stress, if not reduced or controlled, can cause significant deformation or warping of the article.

One method for dealing with warping or other undesirable deformation of rotationally molded articles is to modify the shape of the mold to anticipate potential warping. Warping can also be reduced through proper attention to the placement of the internal frame member with respect to a shrink-neutral axis of the article. Additionally, whether the frame bonds to the internal foam core material or not will also affect the nature and degree of internal stress. These problems can cause additional warping, or make the warping more severe or difficult to predict.

The inventors have found it desirable to use a frame member that does not bond to the material of the foam core. If the beam 14 does not bond to the expanded foam material of the core 20, the foam material can “slide” along the sides of the beam as it shrinks, and only a small, localized shrinkage region adjacent to an end of a beam may be deformed due to shrinkage. Accordingly, the inventors have found that applying a non-stick coating to the frame members prevents bonding of the foam core to the frame member. Non-stick coatings can also be applied to attachment point devices. For example, the inventors apply the same non-stick coating to the blind fasteners 16 that is applied to the table frame/runner 14. This helps prevent and reduce ripples and other visible deformations in the vicinity of the blind fasteners.

The present invention advantageously prevents post-molding deformation of the molded article in an additional way. With an elongate frame member 14 encased in a foam core 20, shrinkage of the molded article 10 relative to the frame member will tend to cause crushing and consequent deformation and damage (e.g. crushing) to the core material in a shrinkage region adjacent to the end of the frame member, and can affect overall flatness of the table top. Advantageously, the end mount 52 depicted in FIG. 5 creates a cavity or void 98 in the molded article around the end of the elongate frame member. This cavity provides a slip zone or crush zone around the end of the reinforcing member, such that post-molding shrinkage and thermal contraction of the polymer material imposes no stress on the end of the reinforcing member. The foam core material contacts only the sides of the reinforcing member, and post-molding shrinkage of the foam core material thus imposes no stress on the ends of the reinforcing member. An anti-skid pad 100, made of resilient material, such as rubber or rubber-like material, can be provided as a cover to plug the opening of the cavity on the surface of the finished article, for a better appearance and to aid in table stacking. It will be apparent that other materials can also be used for the cover or plug. An intermediate cavity or void 102 is also created by the intermediate mount 56, and can likewise be covered by a similar plug or cover.

The invention thus provides a molded article having a polymer shell and an expanded polymer foam core, with an integral frame encased within the foam core. Advantageously, the article can be produced in a one-pass rotational molding process, either with or without a drop box attached to the mold. The process is quick and efficient, and because of the mount system for reinforcing members, turn-around time for individual molds is reduced. Additionally, the provision of a non-stick coating on the reinforcing members helps reduce deformation around these members, while still providing strong anchorage of the members and structural cooperation between the reinforcing members and the polymer material of the body.

By way of example, and without limitation, the invention can be described as providing a molded table top, comprising a body of polymer material, formed in a mold, an elongate reinforcing member, having an end, substantially encased within the body of polymer material during molding thereof, and a slip zone, defining a void in the body of polymer material around the end of the reinforcing member, such that post-molding shrinkage of the polymer material imposes no stress on the end of the reinforcing member.

As yet another example, the invention can be described as a molded table top, comprising a shell of polymer material defining a table top, a core of expanded foam polymer material encased within the shell, an elongate reinforcing member, having sides and ends, substantially encased within the expanded foam core, and a slip zone, surrounding the ends of the reinforcing member. The slip zone defines a void in the foam core material, such that foam core material contacts only the sides of the reinforcing member, and post-molding shrinkage of the foam core material imposes no stress on the ends of the reinforcing member.

As yet another example, the invention can be described as providing a molded article, comprising a body of polymer material, formed in a mold, having post-molding temperature-related shrinkage properties, and an elongate reinforcing member, having an end, substantially encased within the body of polymer material during molding thereof, having temperature-related shrinkage properties that are substantially different than those of the polymer material. A slip zone is disposed around the end of the reinforcing member, defining a void in the body of polymer material, such that post-molding shrinkage of the polymer material imposes no stress on the end of the reinforcing member.

As yet another example, the invention can be described as providing a system for forming a molded polymer article around a reinforcing member. The system includes a mold, having an inside, a mount attached to the inside of the mold, and a reinforcing member held in place within the mold by the mount. The mount includes a stiffener cavity into which the reinforcing member is placed, the reinforcing member being held in place during molding of the article.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

1. A molded article, comprising:
a rotationally-molded body of polymer material, formed in a mold, having post-molding shrinkage properties;
an elongate reinforcing member, having an end, substantially encased within the body of polymer material during molding thereof, having post-molding shrinkage properties that are substantially different than the post-molding shrinkage properties of the polymer material; and
a slip zone around the end of the reinforcing member, defining a void in the body of polymer material, such that post-molding shrinkage of the polymer material imposes substantially no stress on the end of the reinforcing member.

2. A molded article in accordance with claim 1, wherein the body of polymer material comprises expanded polymer foam material, and the reinforcing member is substantially encased in the expanded foam.

3. A molded article in accordance with claim 1, wherein the body of polymer material comprises a polymer shell and a core of expanded foam polymer material encased within the shell, the reinforcing member being substantially encased within the expanded foam core.

4. A molded article in accordance with claim 1, wherein the slip zone includes an opening in communication with an exterior of the molded article, and further comprising a cover, configured to insert into and cover the opening.

5. A molded article in accordance with claim 1, wherein the rotationally-molded body is a table top.

6. A molded article in accordance with claim 5, wherein the table top comprises a polymer shell and a core of expanded foam polymer material encased within the shell, the reinforcing member being substantially encased within the expanded foam core.

7. A molded article in accordance with claim 5, wherein the reinforcing member is a table runner.

8. A molded article in accordance with claim 5, wherein the slip zone includes an opening in communication with an exterior of the table top, and further comprising a cover, configured to insert into and cover the opening.

9. A system for forming a molded polymer article around a stiffener, comprising:
a mold, having an inside;
a mount, attached to the inside of the mold, having a stiffener cavity; and
a stiffener, having an end, configured to be held in the stiffener cavity during rotational molding of an article in the mold, such that the stiffener becomes substantially encased in the polymer material of the article, and the mount forms a slip zone defining a void around the end of the stiffener.

10. A system in accordance with claim 9, further comprising a mechanical fastener, associated with the mount, configured to hold the stiffener in the stiffener cavity during rotational molding of the polymer article.

11. A system in accordance with claim 9, wherein the mold and the mount are of non-ferromagnetic material, and the stiffener is of ferromagnetic material, and further comprising a magnet, associated with the mount, configured to hold the stiffener in the stiffener cavity during rotational molding of the polymer article.

12. A system in accordance with claim 9, wherein the mold is configured in the shape of a table top, and the stiffener comprises a table runner.

13. A system in accordance with claim 9, wherein the mounts have an elongate shape, and are configured to attached to a side of the mold, so as to form an opening in communication with an exterior of the molded article.

14. A system in accordance with claim 9, wherein the stiffener comprises an elongate member having opposing ends, and the mount comprises at least two mounts disposed at opposing ends of the elongate member, the stiffener cavity of each mount being configured to receive one of the opposing ends of the stiffener.

15. A system in accordance with claim 14, further comprising an intermediate mount, attached to the inside of the mold, configured to stabilize a center portion of the stiffener within the mold.

16. A method for reducing warping of a molded plastic article, comprising the steps of:
placing an elongate reinforcing member into a mold of a rotational molding apparatus; and
rotationally molding a body of polymer material within the mold, the body substantially encasing the elongate reinforcing member, but leaving a void adjacent to an end of the elongate reinforcing member, so as to provide a slip zone around the end of the reinforcing member, such that post-molding shrinkage of the body of polymer material imposes substantially no stress on the end of the reinforcing member.

17. A method in accordance with claim 16, further comprising the steps of:
attaching a mount within the mold;
placing the elongate reinforcing member into the mold with the end of the elongate reinforcing member adjacent to the mount; and
rotationally molding the body of polymer material so as to substantially encase the elongate reinforcing member and the mount.

18. A method in accordance with claim 17, further comprising the step of removing the mount from the body after rotational molding, an exposed outer surface of the mount defining the slip zone around the end of the reinforcing member.

19. A method in accordance with claim 17, further comprising the step of removably attaching the elongate reinforcing member to the mount, so as to stabilize the reinforcing member within the mold.

20. A method in accordance with claim 16, wherein the step of rotationally molding comprises forming a shell of polymer material within the mold, and forming an expanded foam core within the shell, the elongate reinforcing member being substantially encased within the foam core.
